(19) United States
(12) Patent Application Publication
(10) Pub. No.: US 2006/0044398 A1
(43) Pub. Date: Mar. 2, 2006

(54) Digital image classification system

(76) Inventors: Annie P. Foong, Aloha, OR (US); Tom R. Huff, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/931,319

(22) Filed: Aug. 31, 2004

(51) Int. Cl. H04N 5/225

(52) U.S. Cl. 348/207.99; 348/231.2

(57) ABSTRACT

Techniques are described to identify and categorize digital images based on the content encoded with the digital image.

### BACKGROUND

A digital camera may capture digital images. The number of digital images stored by a digital camera may depend upon the amount of memory resources available to the digital camera. With the increasing amount of memory resources available to digital cameras, a digital camera may store hundreds if not thousands of digital images. These digital images may be transferred to another device, such as a personal computer (PC). A user may then store the digital images in the hard drive of the PC. Typically, the user stores the digital images by category, such as family, friends, location, event, and so forth. Given the sheer number of potential digital images, this classification operation may be tedious and time consuming. Consequently, there may be a need for more efficient techniques to assist a user in performing these and other operations.

### BRIEF DESCRIPTION OF THE DRAWINGS

FIG. 1 illustrates a block diagram of a system 100.

FIG. 2 illustrates a block diagram of a digital camera 102.

FIG. 3 illustrates a block diagram of an image processing node 104.

FIG. 4 illustrates a block flow diagram of a processing logic 400.

FIG. 5 illustrates examples of content information.

### DETAILED DESCRIPTION

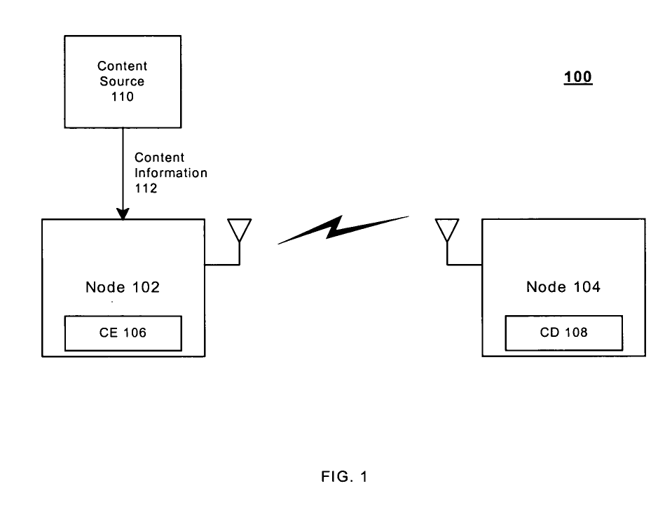

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a digital camera, digital video recorder, a digital camera/recorder (“camcorder”), computer, server, workstation, laptop, ultra-laptop, handheld computer, telephone, cellular telephone, personal digital assistant (PDA), and so forth. The unique address may comprise, for example, a network address such as an Internet Protocol (EP) address, a device address such as a Media Access Control (MAC) address, and so forth. The embodiments are not limited in this context.

The nodes of system 100 may be connected by one or more types of communications media and input/output (I/O) adapters. The communications media may comprise any media capable of carrying information signals. Examples of communications media may include metal leads, semiconductor material, twisted-pair wire, co-axial cable, fiber optics, radio frequency (RF) spectrum, and so forth. An information signal may refer to a signal which has been coded with information. The I/O adapters may be arranged to operate with any suitable technique for controlling information signals between nodes using a desired set of communications protocols, services or operating procedures. The I/O adapters may also include the appropriate physical connectors to connect the I/O adapters with a corresponding communications media. Examples of an I/O adapter may include a network interface, a network interface card (NIC), radio/air interface, disc controllers, video controllers, audio controllers, and so forth. The embodiments are not limited in this context.

The nodes of system 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth.

Referring again to FIG. 1, system 100 may comprise a node 102, a node 104, and an external content source 110. Although FIG. 1 is shown with a limited number of elements in a certain topology, it may be appreciated that system 100 may include more or less elements in any type of topology as desired for a given implementation. The embodiments are not limited in this context.

In one embodiment, node 102, node 104 and/or external content source 110 may comprise wireless nodes arranged to communicate information over a wireless communication medium, such as infrared or RF spectrum. A wireless node may comprise any of the nodes previously described with additional components and interfaces suitable for communicating information signals over the designated wireless spectrum. For example, the wireless nodes may include omni-directional antennas, wireless transceivers, amplifiers, filters, control logic, and so forth. The embodiments are not limited in this context.

In one embodiment, system 100 may comprise node 102. Node 102 may comprise a device to capture analog images and store the analog images in accordance with a given digital format to form a digital image. Examples for node 102 may include a digital camera, digital video recorder, a combination of both such as video camcorder, a cellular telephone with an integrated digital camera, and so forth. Node 102 may also include a wireless transceiver and antenna to communicate the digital images and other information with other devices, such as node 104, for example.

In one embodiment, for example, node 102 may be implemented as a digital camera. A digital camera may capture an image of particular subject using an imaging system. The imaging system may include an optical lens and a photosensor array, such as a charged coupled device (CCD). The imaging system may capture a digital image that represents a particular subject at a given instant of time. The digital image may then be stored in a memory device for subsequent viewing on a display device, printing onto paper, or downloading to a computer system. Although node 102 may be described using a digital camera by way of example, the embodiments are not limited in this context.

Digital camera 102 may be used to capture a number of digital images. In some implementations, for example, digital camera 102 may include sufficient memory resources to capture and store a large number of digital images. As a result, the management of such a large number of digital images may become more difficult as memory resources increases. For example, to catalog the digital images may require manually keying in a title at the time of capture, or manually post-processing each digital image after downloading. Either way may be tedious and time-consuming, and may also be dependent on the memory and accuracy of the input user.

Some embodiments attempt to solve these and other problems by automatically encoding a minimum set of content information for each digital image at the time the digital image is captured. The term “content information” as used herein may refer to any information that may be used to identify the content or subject matter of a digital image. Using certain post-processing techniques as discussed with image processing node 104, the content information may be used to perform more extensive gathering of content information beyond the initial set of content information captured by digital camera 102. For example, if the content information captured by digital camera 102 includes location information from a global positioning system (GPS), the location information may be used to automatically index and link to websites with more derived information about the place, such as interesting things to see, hotels, satellite photos of the place, history of the place, and so forth. The content information may also enable automatically categorizing (“auto-categorizing”) digital images for storing and retrieving digital images from memory, such as indexing and storing pictures by categories (e.g., vacation, location, individuals, pets, and so forth). The term “automatically” as used herein may refer to operations performed without, or with limited, human intervention.

In one embodiment, for example, digital camera 102 may include a content encoder 106. Content encoder 106 may encode a digital image with content information at the time of capture. The content information may originate from a content source internal or external to digital camera 102. Content encoder 106 may receive the content information, and encode a digital image with the content information to form an encoded digital image.

In one embodiment, system 100 may include external content source 110. External content source 110 may provide content information 112 to digital camera 102. Digital camera 102 may receive the content information from external content source 110, and use content information 112 for a number of different post-processing operations, as described later. An example of external content source 110 may include an electronic sign (“e-sign”) placed at a tourist site. The e-sign may broadcast various types of pre-programmed content information to visitors, such as content information regarding the tourist site, special events, associated displays, weather reports, history or background information, and so forth. Another example of external content source 110 may include a personal e-sign. The personal e-sign may be pre-programmed with information about a specific person or object, such as the user of digital camera 102, any person within the view of the camera, any person within a predefined radius of digital camera 102, and so forth. The personal e-sign may be arranged to broadcast the information to digital camera 102 when digital camera 102 is used to capture a digital image, for example. The embodiments are not limited in this context.

External content source 110 may communicate content information 112 to digital camera 102 in a number of different ways. For example, external content source 110 may communicate content information 112 to digital camera 102 using wireless techniques. In this case, external content source 110 may be arranged to broadcast content information 112 on a continuous basis. Alternatively, external content source 110 may be arranged to periodically broadcast content information 112 at predefined time intervals. External content source 110 may also be arranged to broadcast content information 112 in response to a request, such as from a user manually activating external content source 110, digital camera 102 sending an electronic request to external content source 110, and so forth. The embodiments are not limited in this context.

In addition to wireless techniques, external content source 110 may also communicate content information 112 using a number of alternative techniques. For example, external content source 110 may communicate content information 112 to digital camera 102 using barcodes and barcode readers. In this case, external content source 110 may include one or more barcodes representing content information 112, and digital camera 102 may include a barcode reader that may scan the barcodes and retrieve content information 112 from the barcodes. In yet another example, external content source 110 may include a low-frequency infra-red (IR) encoder and digital camera 102 may include a corresponding low-frequency IR decoder. The embodiments are not limited in this context.

External content source 110 may also be arranged to perform encryption and authentication operations as desired for a given implementation. In this manner, for example, external content source 110 may limit communication of content information 112 to only a certain type or class of devices.

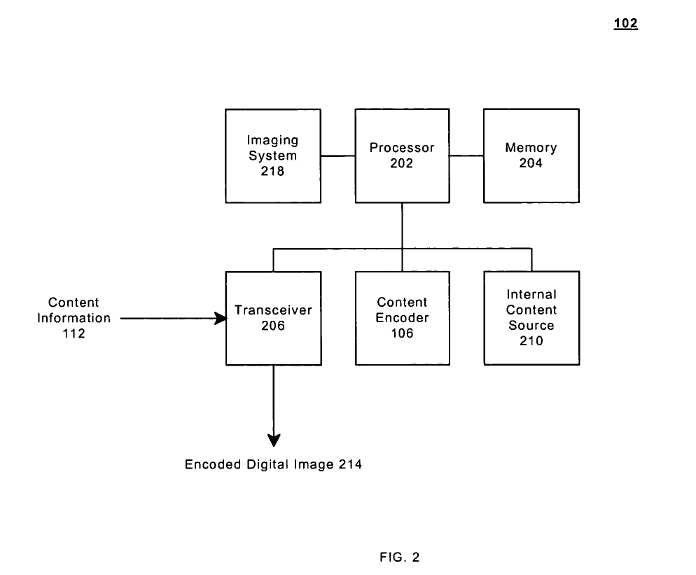

In one embodiment, digital camera 102 may include one or more internal or attached components that are arranged to provide content information for a digital image. For example, digital camera 102 may include a GPS module that is integrated with, or may be attached to, digital camera 102. In another example, digital camera 102 may include a voice recorder to record audio information from a user. In yet another example, digital camera 102 may include a time/date clock to provide a time and date stamp. In still another example, digital camera 102 may include a keyboard or other alphanumeric keypad or input device to provide text information. These and other internal content sources may be discussed in more detail with reference to FIG. 2.

The content information gathered from various internal or external content sources may include any type of information that may be used to assist in the identification of the subject matter or content for a given digital image. The different types of content information may be generally categorized as permanent content information, temporal content information, user-specific content information, and technique content information. Permanent content information may refer to those features in a digital image that are relatively permanent and that do not typically change over the course of time. Examples of permanent content information may include location information for a place, natural geographical features, man-made structures, and so forth. The location information may include, for example, longitude and latitude coordinates corresponding to a map. Temporal content information may comprise time-based content information. Examples of temporal content information may include a time stamp, an event that is scheduled for a certain period of time, current weather conditions, predicted weather conditions, and so forth. User-specific content information may comprise content information specific to a person or group of individuals. Examples of user-specific content information may include the name of a person, a special event associated with the person (e.g., birthday), and so forth. Technique content information may comprise techniques or values associated with a digital image. Examples of technique content information may include color balance, resolution, zoom, aperture, and so forth. It may be appreciated that the types of content information as described herein are by way of example only, and the embodiments are not necessarily limited in this context.

In one embodiment, system 100 may comprise node 104. Node 104 may comprise, for example, an image processing node. An image processing node may comprise a processing system such as a computer arranged to perform back end or post-processing operations for digital images. Examples of post-processing operations may include decoding the content information from an encoded digital image, retrieving additional content information for the digital image, classifying and storing the digital image, retrieving the digital image using an index, and so forth. Image processing node 104 may include a transceiver or network interface to receive encoded digital images from node 102.

In one embodiment, node 104 may include a content decoder 108. Content decoder 108 may decode content information from encoded digital images received from digital camera 102. The content information may be used to identify the content of each digital image. The digital image may then be stored in an organized manner to facilitate retrieval by a user. For example, the content information may indicate that a digital image is of a particular individual, such as a family member, and the digital image may be indexed and stored with other digital images of the same individual. Similarly, the content information may indicate that the digital information is of a particular place, such as a vacation destination, and the digital image may be indexed and stored with other digital images of the same place. The above description is given by way of example, and the embodiments are not limited in this context.

The content information obtained by content decoder 108 may be used in a number of different ways. For example, content decoder 108 may be arranged to auto-categorize and store each digital image using the content information and a set of predefined classification rules. The classification rules may be selected by a user to suit individual preferences, or may include a set of default classification rules to conform to a standard or general set of preferences. Alternatively, the content information may be displayed to a user via a display for image processing node 104, and the user may manually classify each digital image and store it in the desired manner. The embodiments are not limited in this context.

In general operation, a user may use digital camera 102 to capture and store a number of different digital images. The transceiver of digital camera 102 may receive content information 112 from external content source 110 or an internal content source. Content encoder 106 may encode each digital image with content information 112 to form encoded digital images. Digital camera 102 may accumulate content information 112 at approximately the same time as when the digital image is captured. Alternatively, content information 112 may be received before or after the relevant digital image has been captured. Digital camera 102 may communicate the encoded digital images to image processing node 104 via a wireless transceiver. Image processing node 104 may perform back end or post-processing operations on the encoded digital images. For example, content decoder 108 may decode the content information from the encoded digital images. The decoded content information may be used to classify the digital images, and store the digital images in accordance with the classification.

Although the embodiments may be illustrated in the context of a wireless communications system, it may be appreciated that the principles discussed herein may also be implemented in a wired communications system as well. For example, digital camera 102 and image processing node 104 may communicate information such as encoded digital images over a wired communications medium. Image processing node 104 may include the appropriate hardware and software interfaces to physically connect digital camera 102 to image processing node 104. For example, image processing node 104 may include a cradle sized to accommodate a digital camera, with electrical contacts to transfer the encoded digital images to node 104. In another example, digital camera 102 and image processing node 104 may both include a physical port arranged to communicate the encoded digital images over a wired communication medium in accordance with a wired communications protocol, such as the IEEE 1394 “Firewire” family of standards or universal serial bus (USB) standard. In yet another example, digital camera 102 and image processing node 104 may both include a network interface to connect to a packet network, such as the Internet. Digital camera 102 may then communicate the encoded digital images to image processing node 104 over the packet network. The embodiments are not limited in this context.

FIG. 2 illustrates a block diagram of digital camera 102. As shown in FIG. 2, digital camera 102 may include processor 202, memory 204, transceiver 206, content encoder 106, internal content source 210, and imaging system 218. Although FIG. 2 shows a limited number of elements, it can be appreciated that more or less elements may be used in digital camera 102 as desired for a given implementation. The embodiments are not limited in this context.

In one embodiment, digital camera 102 may include imaging system 218. Imaging system 218 may include imaging optics that may include a single lens or a lens array positioned to collect optical energy representative of a subject or scenery, and to focus the optical energy onto a photosensor array, such as a CCD. The photosensor array may define a matrix of photosensitive pixels. Each photosensitive pixel may generate an electrical signal that is representative of the optical energy that is directed at the pixel by the imaging optics. The electrical signals that are output by the photosensor array may be characterized as image data or digital image data, wherein each image or picture that is captured is considered one set or frame of the digital image data to form a particular digital image. The imaging system may capture a digital image that represents a particular subject at a given instant of time. The digital image may then be stored in a memory device for subsequent viewing on a display device, printing onto paper, or downloading to a computer system for processing, such as image processing node 104.

In one embodiment, digital camera 102 may include processor 202. Processor 202 may be used for various operations of digital camera 102. For example, processor 202 may execute program instructions to perform various data management operations for digital camera 102. Processor 202 may also execute program instructions to perform various image processing operations, such as enhancing the raw digital image data in order to improve the quality or resolution of the digital image, perform data compression in order to decrease the quantity of data used to represent the digital image, perform data decompression to display previously compressed data, perform run length encoding and delta modulation, and so forth. Processor 202 may also execute program instructions to perform content encoding, such as for content encoder 106, for example.

In one embodiment, processor 202 can be any type of processor capable of providing the speed and functionality desired for a given implementation. For example, processor 202 could be a processor made by Intel( Corporation and others. Processor 202 may also comprise a digital signal processor (DSP) and accompanying architecture. Processor 202 may further comprise a dedicated processor such as a network processor, embedded processor, micro-controller, controller and so forth.

In one embodiment, digital camera 102 may include memory 204. Memory 204 may comprise electronic or magnetic memory, such as flash memory, read-only memory (ROM), random-access memory (RAM), programmable ROM, erasable programmable ROM, electronically erasable programmable ROM, dynamic RAM, synchronous RAM (SRAM), dynamic SRAM, magnetic disk (e.g., floppy disk and hard drive), optical disk (e.g., CD-ROM or DVD), and so forth. In one embodiment, for example, memory 204 may comprise flash memory that may be removed from digital camera 102. In this case, encoded digital images may be transferred to image processing node 104 using the removable flash memory rather than transceiver 206. The embodiments are not limited in this context.

In one embodiment, digital camera 102 may include transceiver 206. Transceiver 206 may comprise a wireless transceiver arranged to communicate information in accordance with a wireless communications protocol over a wireless communications medium. For example, transceiver 206 may be arranged to communicate using a wireless communications protocol as defined by the IS-95 Mobile Radio Standard. The IS-95 Mobile Radio Standard is a protocol using code division multiple access (CDMA) and quadrature phase shift-keying (QPSK)/bipolar phase shift-keying (BPSK) modulation on a carrier frequency of 824-994 megahertz (MHz) or 1.8-2.0 gigahertz (GHz). Other wireless communications protocols may include, for example, the IEEE 802.12 and 802.16 family of protocols, the Bluetooth protocol, one or more cellular telephone protocols such as the wireless access protocol (WAP), IR protocols, and so forth. The embodiments are not limited in this context.

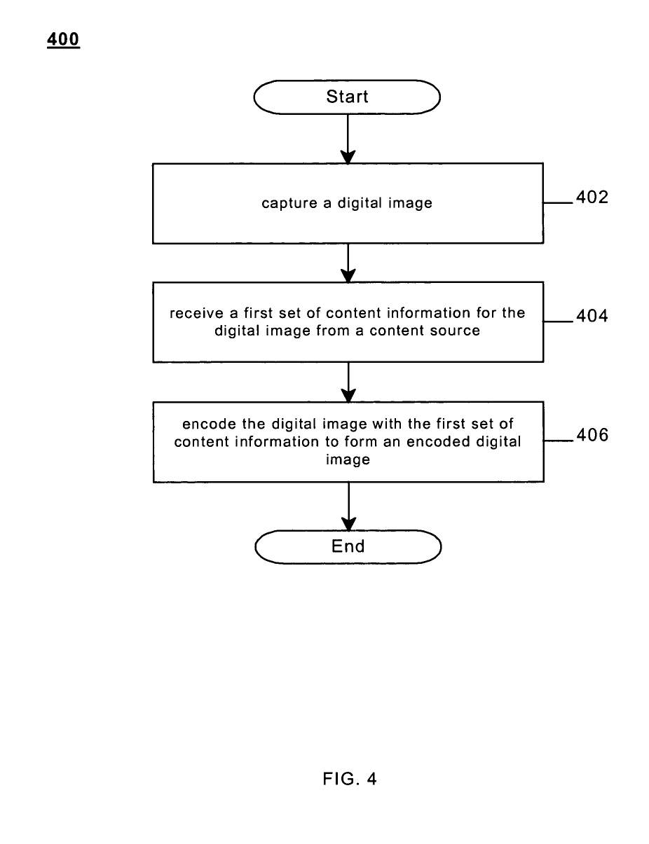

In one embodiment, digital camera 102 may include content encoder 106. Content encoder 106 may encode digital images with content information. The content information may come from various internal or external content sources, such as from external content source 110, internal content source 210, and so forth. Content encoder 106 may be implemented as software executed by processor 202, hardware, or a combination of both. The operations of content encoder 106 may be described in more detail with reference to FIG. 4.

In one embodiment, digital camera 102 may include internal content source 210. Internal content source 210 may include any device, component, system or module internal to digital camera 102, or attached to digital camera 102, that is capable of providing content information. Examples of internal content source 210 may include a GPS module to provide location information, a voice recorder to record audio information from a user, a time/date clock to provide a time and date stamp, a keyboard or keypad to enter text information, and so forth. The embodiments are not limited in this context.

In one embodiment, for example, internal content source 210 may comprise a GPS module. The GPS module may include any conventional GPS capable of providing location information for an object, such as digital camera 102. The GPS module may have a receiver separate from, or integrated with, transceiver 206. The GPS module may receive digital radio signals from one or more GPS satellites. The digital radio signals may contain data on the satellites location and a predetermined time to the earth-bound receivers. The satellites are equipped with atomic clocks that are precise to within a billionth of a second. Based on this information the receivers should know how long it takes for the signal to reach the receiver on earth. As each signal travels at the speed of light, the longer it takes the receiver to get the signal, the farther away the satellite may be located. By knowing how far away a satellite is, the receiver knows that it is located somewhere on the surface of an imaginary sphere centered at the satellite. By using three satellites, the GPS module can calculate location information for digital camera 210 using the longitude and latitude of the receiver based on where the three spheres intersect. By using four satellites, the GPS module can also determine altitude.

The GPS information may be used with various post-processing operations to identify a location or structure that is the content of a digital image. The GPS information may be used in conjunction with a proprietary or commercially available database to associate a location with a point of interest. This may be augmented with a personal database for a user for non-public places, such as the house of a friend or relative, for example.

In one embodiment, for example, internal content source 210 may comprise a voice recorder. The voice recorder may be a digital voice recorder to store voice information from a user. Voice recorder may be manually activated using a switch or button placed on digital camera 102, or may be arranged to activate in response to detecting voice signals, such as a voice-activated voice recorder. When internal content source 210 is implemented as a voice recorder, digital camera 102 may also include a voice-to-text module to convert the voice information to text information. The text information may be an example of user-specific content information.

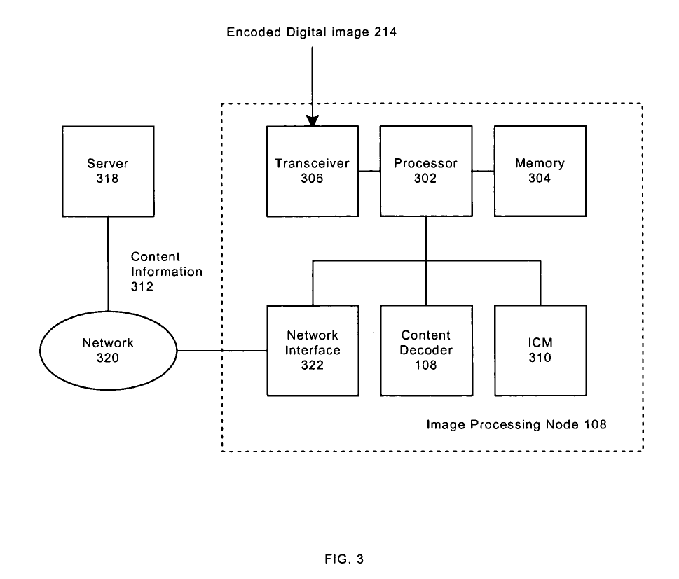

FIG. 3 illustrates a block diagram of image processing node 104. As shown in FIG. 3, image processing node 104 may include processor 302, memory 304, transceiver 306, content decoder 108, and an image classification module (ICM) 310. FIG. 3 also shows a server 318 and a network 320. Although FIG. 3 shows a limited number of elements, it can be appreciated that more or less elements may be used in image processing node 104 as desired for a given implementation. The embodiments are not limited in this context.

In one embodiment, image processing node 108 may include processor 302 and memory 304. Processor 302 and memory 304 of image processing node 108 may be similar to processor 202 and memory 204 of digital camera 102 as described with reference to FIG. 2. In actual implementation, however, these elements are typically larger, faster and more powerful as appropriate to a computer, such as a PC, workstation, laptop, server, and so forth. The embodiments are not limited in this context.

In one embodiment, image processing node 108 may include transceiver 306. Transceiver 306 may be similar to transceiver 206 as described with reference to FIG. 2. Transceiver 306 may be used to receive information from digital camera 102, such as one or more encoded digital images 214.

In one embodiment, image processing node 108 may include content decoder 108. Content decoder 108 may decode content information from encoded digital images 214. Content decoder 108 may be implemented as software executed by processor 202, hardware, or a combination of both. The operations of content decoder 108 may be described in more detail with reference to FIG. 4.

In one embodiment, image processing node 108 may include ICM 310. ICM 310 may automatically classify and store digital images in accordance with content information retrieved by content decoder 108. ICM 310 may be arranged to determine a category for each digital image using the decoded content information in accordance with a set of classification rules. ICM 310 may then store each digital image in a memory such as memory 304 using the category. For example, memory 304 may comprise multiple folders, with each folder being identified with a category name. ICM 310 may determine the appropriate category for a digital image, and then store the digital image in the appropriate folder with the same category name. In this manner, each category may be used as an index to store and retrieve the digital images. Content information may be stored with the digital image to facilitate searches and retrieval for a digital image, class of digital image, type of digital image, and so forth. The embodiments are not limited in this context.

In one embodiment, image processing node 108 may include a network interface 322. Network interface 322 may comprise an I/O adapter arranged to operate in accordance with various packet protocols, such the IEEE Transport Control Protocol (TCP) and Internet Protocol (IP), although the embodiments are not limited in this context. Network interface 322 may also include the appropriate connectors for connecting network interface 322 with a suitable communications medium. The embodiments are not limited in this context.

In one embodiment, image processing node 108 may communicate with server 318 via network 320 using network interface 322. Network 320 may comprise, for example, a packet network such as the Internet and/or World Wide Web (WWW). Server 318 may comprise a server having a website with content information 312. Content information 312 may be similar to content information 212. Given the greater amount of memory resources available to server 318, however, content information 312 may comprise a larger and more detailed set of content information than made available by external content source 110. Server 318 may host a website and store content information 312 in a database in a number of different formats. For example, server 318 may store content information 312 in the form of Hypertext Markup Language (HTML) documents, Extensible Markup Language (XML) documents, Sequel (SQL) documents, and so forth. The embodiments are not limited in this context.

In one embodiment, it may be desirable to have additional content information for a digital image in addition to the content information decoded from the encoded digital image 214 by content decoder 108. In this case, the decoded content information such as content information 112 may be used to retrieve a more detailed set of content information, such as content information 312 from server 318 via network 320. For example, assume content information 112 includes location information for a particular place, such as The Washington Monument located in Washington, D.C. ICM 310 may initiate a connection to server 318 via network 320, and attempts to search server 318 for tourist sites corresponding to the location information received from content decoder 108. Server 318 may identify that the location information corresponds to The Washington Monument. ICM 310 may proceed to gather additional content information regarding The Washington Monument, including profiles, history, statistics, photos, hotels, transportation, and so forth. ICM 310 may use the additional content information 312 to determine a category for the digital image in accordance with the classification rules, and index the digital image using the category. Alternatively, content information 312 may be stored with the digital image as index information or supplemental information. The embodiments are not limited in this context.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

FIG. 4 illustrates a programming logic 400. Programming logic 400 may be representative of the operations executed by one or more systems described herein, such as system 100, digital camera 102, and/or image processing node 104. As shown in programming logic 400, a digital image may be captured at block 402. A first set of content information for the digital image may be received from a content source at block 404. The first set of content information comprises content information from a group of content information comprising permanent content, temporal content, user-specific content, and technique content. The digital image may be encoded with the first set of content information to form an encoded digital image at block 406.

In one embodiment, the encoded digital image may be received. The first set of content information may be decoded from the encoded digital image. The digital image may be stored in accordance with the first set of content information.

In one embodiment, the digital image may be stored by determining a category for the digital image using the first set of content information in accordance with a set of classification rules. The digital image may then be indexed using the category.

In one embodiment, the digital image may be stored by retrieving a second set of content information from a server using the first set of content information. A category may be determined for the digital image using the second set of content information in accordance with a set of classification rules. The digital image may be indexed using the category.

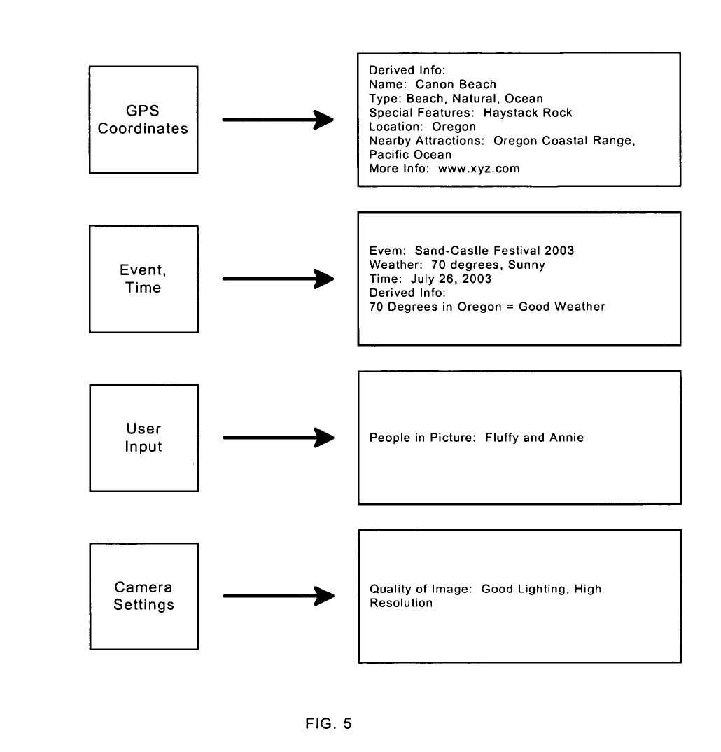

FIG. 5 illustrates examples of content information. FIG. 5 illustrates some examples of a first set of content information as received by digital camera 102 from external content source 110 or internal content source 210. FIG. 5 may also illustrate some examples of a how the first set of content information may be used to auto-categorize a digital image, such as using the first set of content information to derive a second set of content information, such as content information 312 from server 318. The first set of content information and/or the second set of content information may be used with a set of classification rules to auto-categorize the digital image.

In a first example, assume the first set of content information comprises permanent content information such as location information. The location information may comprise GPS coordinates from internal content source 210. ICM 310 may use the GPS coordinates to retrieve a second set of content information from server 318, such as the name of a popular destination site corresponding to the GPS coordinates, the type of location, special features, the state where the destination site is located, nearby attractions, and a website of where to find additional information.

In a second example, assume the first set of content information comprises temporal content information. The temporal content information may comprise a time stamp, event information, and weather information, received from external content source 110. ICM 310 may use the temporal content information to retrieve a second set of content information from server 318, such as what constitutes ideal weather conditions for the location where the event is hosted.

In a third example, assume the first set of content information comprises user-specific content information, such as the name of the person in the picture and a favorite pet. The user-specific content information may be received from an external content source such as a personal e-sign for the user of the digital camera, or internal content source 210 such as text information inputted by the user or converted from a voice recording recorded by the user. In this case there may not necessarily be a need for a second set of content information. ICM 310 may use the first set of content information to auto-categorize the digital image. ICM 310 may also use a set of classification rules to auto-categorize the digital image. For example, a classification rule may be defined such as if a digital image contains multiple subjects including a person and a pet, the digital image should be stored in a folder for the person, the pet, or both. The embodiments are not limited in this context.

In a fourth example, assume the first set of content information comprises technique content information, such as a lighting information and resolution information. The technique content information may be received from internal content source 210, or some other component of digital camera 102, such as processor 202, imaging system 218, and so forth. ICM 310 may use a set of classification rules to determine a level of quality associated with the digital image derived using the lighting information and resolution information. For example, the classification rules may be defined such as if a digital image has a first number of pixels it should be identified as a “high quality” image, if the digital image has as a second number of pixels it should be identified as a “medium quality” image, and if the digital image has a third number of pixels it should be identified as a “low quality” image. ICM 310 may compare the actual number of pixels encoded with the digital image with the classification rules, and determine whether the digital image should be stored as a high quality image, medium quality image, or low quality image. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or DSP, and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A digital camera, comprising:
an imaging system to capture a digital image;
a transceiver to receive a first set of content information; and
a content encoder to encode said digital image with said first set of content information to form an encoded digital image.

2. The digital camera of claim 1, further comprising a memory to store said encoded digital image.

3. The digital camera of claim 1, wherein said transceiver is to receive said first set of content information from a content source.

4. The digital camera of claim 1, wherein said first set of content information comprises content information from a group of content information comprising permanent content, temporal content, user-specific content, and technique content.

5. The digital camera of claim 1, further comprising a global positioning system to generate location information, said location information to comprise permanent content for said first set of content information.

6. An image processing node, comprising:
a transceiver to receive an encoded digital image;
a content decoder to decode a first set of content information from said digital image; and
an image classification module to classify and store said digital image in accordance with said first set of content information.

7. The image processing node of claim 6, wherein said image classification module is arranged to determine a category for said digital image using said first set of content information in accordance with a set of classification rules, and index said digital image using said category.

8. The image processing node of claim 6, wherein said image classification module is arranged to retrieve a second set offcontent information from a server using said first set of content information, determine a category for said digital image using said second set of content information in accordance with a set of classification rules, and index said digital image using said category.

9. The image processing node of claim 6, wherein said first set of content information comprises content information from a group of content information comprising permanent content, temporal content, user-specific content, and technique content.

10. The image processing node of claim 9, wherein said permanent content includes location information from a global positioning system.

11. A system, comprising:
a digital camera having an imaging system, a first transceiver and a content encoder, said imaging system to capture a digital image, said first transceiver to receive a first set of content information, and said content encoder to encode said digital image with said first set of content information to form an encoded digital image; and
an image processing node to couple to said digital camera, said image processing node having a second transceiver, a content decoder and an image classification module, said second transceiver to receive said encoded digital image, said content decoder to decode said first set of content information from said digital image, and said image classification module to classify and store said digital image in accordance with said first set of content information.

12. The system of claim 11, wherein said first set of content information comprises content information from a group of content information comprising permanent content, temporal content, user-specific content, and technique content.

13. The system of claim 11, further comprising a content source to provide said first set of content information, said content source to comprise an electronic sign.

14. The system of claim 11, further comprising a first antenna to connect to said first transceiver, and a second antenna to connect to said second transceiver.

15. The system of claim 11, further comprising a server to store a second set of content information, and wherein said image classification module is to retrieve said second set of content information from said server using said first set of content information, determine a category for said digital image using said second set of content information in accordance with a set of classification rules, and index said digital image using said category.

16. The system of claim 11, wherein said digital camera further comprises a global positioning system to generate location information, said location information to comprise permanent content for said first set of content information.

17. A method, comprising:
capturing a digital image;
receiving a first set of content information for said digital image from a content source; and
encoding said digital image with said first set of content information to form an encoded digital image.

18. The method of claim 17, wherein said first set of content information comprises content information from a group of content information comprising permanent content, temporal content, user-specific content, and technique content.

19. The method of claim 17, further comprising:
receiving said encoded digital image;
decoding said first set of content information from said encoded digital image; and
storing said digital image in accordance with said first set of content information.

20. The method of claim 19, wherein said storing comprises:
determining a category for said digital image using said first set of content information in accordance with a set of classification rules; and
indexing said digital image using said category.

21. The method of claim 19, wherein said storing comprises:
retrieving a second set of content information from a server using said first set of content information;
determining a category for said digital image using said second set of content information in accordance with a set of classification rules; and
indexing said digital image using said category.

22. An article, comprising:
a storage medium;
said storage medium including stored instructions that, when executed by a processor, are operable to capture a digital image, receive a first set of content information for said digital image from a content source, and encode said digital image with said first set of content information to form an encoded digital image.

23. The article of claim 22, wherein the stored instructions, when executed by a processor, are further operable to receive said encoded digital image, decode said first set of content information from said digital image, and store said digital image in accordance with said first set of content information.

24. The article of claim 22, wherein the stored instructions, when executed by a processor, perform said storing using stored instructions operable to determine a category for said digital image using said first set of content information in accordance with a set of classification rules, and index said digital image using said category.

25. The article of claim 22, wherein the stored instructions, when executed by a processor, perform said storing using stored instructions operable to retrieve a second set of content information from a server using said first set of content information, determine a category for said digital image using said second set of content information in accordance with a set of classification rules, and index said digital image using said category.
